(19) United States
(12) Patent Application Publication
(10) Pub. No.: US 2008/0047844 A1
(43) Pub. Date: Feb. 28, 2008

(54) Method of generating electrolyzed water and electrolyzed water generation apparatus therefor

(75) Inventor: Kohichi Miyashita, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD.

(21) Appl. No.: 11/892,059

(22) Filed: Aug. 20, 2007

(30) Foreign Application Priority Data
Aug. 28, 2006 (JP) 2006-230624

(51) Int. Cl. C02F 1/461; C25B 9/00

(52) U.S. Cl. 205/743; 204/232; 205/746

(57) ABSTRACT

A method and apparatus for generating electrolyzed water easy to carry out or handle even in ordinary homes. An electrolyte aqueous solution is circuited through a first electrolysis chamber 3a of two electrolysis chambers placed on opposite sides of an ion-permeable membrane 2, and raw water is supplied only to the second electrolysis chamber 3b. A voltage is applied between electrodes 7a and 7b to cause electrolysis. Electrolyzed water generated in the second electrolysis chamber 3b is drawn out. The concentration of the electrolyte aqueous solution circulated through the first electrolysis chamber 3a is maintained within a predetermined range. The membrane 2 is an anion-exchange membrane. The electrolyte aqueous solution is circulated through the first cathode-side electrolysis chamber 3a; raw water is supplied only to the second anode-side electrolysis chamber 3b; and acid electrolyzed water generated in the anode-side electrolysis chamber 3a is drawn out. The electrolyte aqueous solution is NaCl or KCl aqueous solution. The concentration is maintained within the predetermined range by adding hydrochloric acid according to the pH of the NaCl or KCl solution or the amount of reaction of this solution computed from the amount of energization during the electrolysis.

### BACKGROUND OF THE INVENTION

1. Field of the Invention

The present invention relates to a method of generating acid or alkaline electrolyzed water and an electrolyzed water generation apparatus therefor.

2. Description of the Related Art

A method of generating electrolyzed water is known in which electrodes are respectively disposed in a pair of opposed electrolysis chambers having an ion-permeable membrane therebetween such as an anion-permeable membrane; raw water is supplied to each electrolysis chamber; and a voltage is applied between the electrodes to electrolyze the raw water supplied to each electrolysis chamber. According to this conventional method, a chloride such as sodium chloride is added as an electrolyte to the raw water to obtain acid electrolyzed water containing hypochlorous acid from the electrolysis chamber on the anode side and to obtain alkaline electrolyzed water from the electrolysis chamber on the cathode side.

The above-described acid electrolyzed water has a higher sterilization effect because of the oxidizing power of the hypochlorous acid or the like and finds use for sterilization or the like in medical institution or the like. The above-described alkaline electrolyzed water is used for washing or the like. However, there are only a small number of instances of use requiring both the acid electrolyzed water and the alkaline electrolyzed water. In ordinary cases, only one of the acid and alkaline electrolyzed waters is used, while the other is thrown away as waste water without being used. In such cases, half the amount of raw water is discharged as a waste. This is problematic in terms of resource saving.

To solve the above-described problem, a method has been proposed in which electrolysis of raw water and a solution containing an electrolyte (hereinafter referred to as “electrolyte aqueous solution”) is performed by supplying raw water to only one of two electrolysis chambers and by circulating the electrolyte aqueous solution through the other electrolysis chamber, and in which electrolyzed water generated in the electrolysis chamber to which raw water is supplied is drawn out (see, for example, Japanese Patent Laid-Open No. 9-220572).

According to the method described in the above-mentioned publication, if acid electrolyzed water is needed, electrolysis is performed by using as an anode the electrode disposed in the electrolysis chamber to which raw water is supplied and by using as a cathode the electrode disposed in the electrolysis chamber through which the electrolyte aqueous solution is circulated. As a result, acid electrolyzed water is generated in the electrolysis chamber (on the anode side) to which the raw water is supplied, and this electrolyzed water is drawn out from the electrolysis chamber. At this time, alkaline electrolyzed water is generated in the other electrolysis chamber. However, this electrolyzed water is circulated together with the electrolyte aqueous solution without being discharged as a waste, thus enabling efficient use of resources.

Also, according to the method described in the above-mentioned publication, the electrolyte aqueous solution is circulated between a cartridge-type container and the electrolysis chamber, and the electrolyte aqueous solution in the container is neutralized with acetic acid or the like and discharged as a waste after passage of a predetermined time period.

However, the electrolyte aqueous solution exhibits stronger alkalinity if the circulation time is increased. Therefore the neutralizing operation using acetic acid or the like requires sufficiently elaborate management and is difficult to perform in ordinary homes or the like. Also, the time taken to perform the neutralizing operation is disadvantageously long.

### SUMMARY OF THE INVENTION

In view of the above-described problems, an object of the present invention is to provide an electrolyzed water generation method easy to carry out in ordinary homes or the like and an electrolyzed water generation apparatus used in accordance with the method.

To achieve this object, according to the present invention, there is provided a method of generating electrolyzed water, including the steps of circulating an electrolyte aqueous solution through a first electrolysis chamber as the one of a pair of opposed electrolysis chambers having an ion-permeable membrane therebetween, supplying raw water only to a second electrolysis chamber as the other of the electrolysis chambers, and drawing out electrolyzed water generated in the second electrolysis chamber by applying a voltage between a pair of electrodes disposed in the electrolysis chambers on the opposite sides of the membrane so that the raw water and the electrolyte aqueous solution are electrolyzed, wherein a concentration of the electrolyte aqueous solution circulated through the first electrolysis chamber is maintained within a predetermined range.

In the electrolyzed water generation method of the present invention, acid or alkaline electrolyzed water is generated in the second electrolysis chamber in the pair of electrolysis chambers in correspondence with the polarity of the electrode disposed in the second electrolysis chamber. Then the electrolyzed water is drawn out from the second electrolysis chamber and is utilized in use corresponding to its liquid characteristics.

On the other hand, electrolyzed water reverse in liquid characteristics to that generated in the second electrolysis chamber is generated in the first electrolysis chamber. However, this electrolyzed water is circulated through the first electrolysis chamber together with the electrolyte aqueous solution without being thrown away as waste water, thus enabling efficient use of resources. During repeated cycles of circulation of the electrolyte aqueous solution, the concentration in the electrolyte aqueous solution of the electrolyzed water generated in the first electrolysis chamber increases. According, if the electrolyzed water is alkaline, the electrolyte aqueous solution becomes strongly alkaline. If the electrolyzed water is acid, the electrolyte aqueous solution becomes strongly acid.

According to the electrolyzed water generation method of the present invention, however, the concentration of the electrolyte aqueous solution circulated through the first electrolysis chamber is maintained in the predetermined range to prevent the electrolyte aqueous solution from becoming strongly alkaline or acid even during repeated cycles of circulation. Therefore, there is no need to process the electrolyte aqueous solution that has become strongly alkaline or acid, and the electrolyte aqueous solution can be easily handled even in ordinary homes or the like.

In the electrolyzed water generation method of the present invention, the membrane is, for example, an anion-exchange membrane; the electrolyte aqueous solution is circulated through a cathode-side electrolysis chamber as the first electrolysis chamber; raw water is supplied only to an anode-side electrolysis chamber as the second electrolysis chamber; and the acid electrolyzed water generated in the anode-side electrolysis chamber is drawn out.

When the method is carried out in this way, the electrolyte aqueous solution is only circulated through the cathode-side electrolysis chamber and no raw water is newly supplied to the cathode-side electrolysis chamber. Therefore, no scale is precipitated in the cathode-side electrolysis chamber and the piping connected to the same. There is no need for periodical removal of scale and control for preventing precipitation of scale.

In the case where the electrolyte aqueous solution is circulated through the cathode-side electrolysis chamber, a sodium chloride aqueous solution or a potassium chloride aqueous solution is used as the electrolyte aqueous solution. The concentration of the sodium chloride aqueous solution or a potassium chloride aqueous solution can be maintained within the predetermined range by adding hydrochloric acid thereto.

According to this method, anions (chlorine ions) move from the cathode-side electrolysis chamber into the anode-side electrolysis chamber through the anion-exchange membrane, so that electrolysis can be performed without adding any electrolyte to raw water supplied to the anode-side electrolysis chamber. Also, sodium ions generated by electrolytic dissociation of sodium chloride in the cathode-side electrolysis chamber are blocked by the anion-exchange membrane and cannot move into the anode-side electrolysis chamber. In the anode-side electrolysis chamber, therefore, acid electrolyzed water having a sodium chloride or potassium chloride content not substantially higher than the sodium chloride or potassium chloride content in the raw water can be obtained. As a result, when the acid electrolyzed water is used in an apparatus, corrosion of metals in the apparatus using the acid electrolyzed water is limited.

On the other hand, when the method is carried out in the above-described way, alkaline electrolyzed water is generated in the cathode-side electrolysis chamber and, therefore, the alkalinity of the sodium chloride or potassium chloride aqueous solution gradually becomes stronger. Also in the cathode-side electrolysis chamber, chlorine ions generated by electrolytic dissociation of sodium chloride or potassium chloride move into the anode-side electrolysis chamber by permeating through the anion-exchange membrane to be lost. Then, hydrochloric acid added to the sodium chloride or potassium chloride aqueous solution. The concentration of the sodium chloride or potassium chloride aqueous solution can be easily maintained within the predetermined range thereby.

To maintain the concentration of the sodium chloride or potassium chloride aqueous solution within the predetermined range, the pH of the sodium chloride or potassium chloride aqueous solution for example is measured. When the obtained measured value is larger than a reference value, hydrochloric acid is added to the sodium chloride or potassium chloride aqueous solution so that the pH of the sodium chloride or potassium chloride aqueous solution is lower than the reference value.

To maintain the concentration of the sodium chloride or potassium chloride aqueous solution within the predetermined range, the amount of reaction of the sodium chloride or potassium chloride aqueous solution may be computed from the amount of energization during the above-described electrolysis. In this case, hydrochloric acid is added to the sodium chloride or potassium chloride aqueous solution according to the computed reaction amount.

In the electrolyzed water generation method of the present invention, the membrane, for example, may be an anion-exchange membrane; the electrolyte aqueous solution is circulated through an anode-side electrolysis chamber as the first electrolysis chamber; raw water may be supplied only to a cathode-side electrolysis chamber as the second electrolysis chamber; and the alkaline electrolyzed water generated in the cathode-side electrolysis chamber may be drawn out.

When the method is carried out in this way, anions in the raw water move from the cathode-side electrolysis chamber into the anode-side electrolysis chamber, so that the generated alkaline electrolyzed water contains substantially no anions (Cl⁻, NO₃⁻ or the like) other than hydroxyl ions (OH⁻). In this case, however, the electrical conductivity in the cathode-side electrolysis chamber becomes lower and the efficiency of electrolysis is slightly reduced.

In the electrolyzed water generation method of the present invention, the membrane may alternatively be a cation-exchange membrane; the electrolyte aqueous solution is circulated through an anode-side electrolysis chamber as the first electrolysis chamber; raw water may be supplied only to a cathode-side electrolysis chamber as the second electrolysis chamber; and the alkaline electrolyzed water generated in the cathode-side electrolysis chamber may be drawn out.

When the method is carried out in this way, cations in the anode-side electrolysis chamber can move into the cathode-side electrolysis chamber by permeating through the cation-exchange membrane, so that the desired electric conductivity between the two electrodes can be easily secured and alkaline electrolyzed water can be easily obtained with low power.

The alkaline electrolyzed water thereby generated is mineral-rich because of the move of cations from the anode-side electrolysis chamber into the cathode-side electrolysis chamber. To constantly maintain the concentration of the electrolyte aqueous solution circuited through the anode-side electrolysis chamber in this case, an alkaline solution is added for neutralization.

The electrolyzed water generation method of the present invention can be carried out with an electrolyzed water generation apparatus having a pair of opposed electrolysis chambers having an ion-permeable membrane therebetween, an electrolyte aqueous solution circulation means for circulating an electrolyte aqueous solution through a first electrolysis chamber as one of the pair of electrolysis chambers, a raw water supply means for supplying raw water only to the second electrolysis chamber as the other of the pair of electrolysis chambers, and an electrolyzed water drawing-out means for drawing out electrolyzed water generated in the second electrolysis chamber by applying a voltage between a pair of electrodes disposed in the electrolysis chambers on the opposite sides of the membrane so that the raw water and the electrolyte aqueous solution are electrolyzed, wherein the electrolyte aqueous solution circulation means includes concentration maintaining means for maintaining a concentration of the electrolyte aqueous solution circulated through the second electrolysis chamber within a predetermined range.

The above-described electrolyzed water generation apparatus may have an anion-exchange membrane as the membrane, electrolyte aqueous solution circulation means for circulating the electrolyte aqueous solution through the cathode-side electrolysis chamber, raw water supply means for supplying raw water only to the anode-side electrolysis chamber and electrolyzed water drawing-out means for drawing out acid electrolyzed water generated in the anode-side electrolysis chamber.

### BRIEF DESCRIPTION OF THE DRAWINGS

FIG. 1 is a diagram schematically showing an example of a configuration of an electrolyzed water generation apparatus of the present invention.

### DETAILED DESCRIPTION OF THE PREFERRED EMBODIMENTS

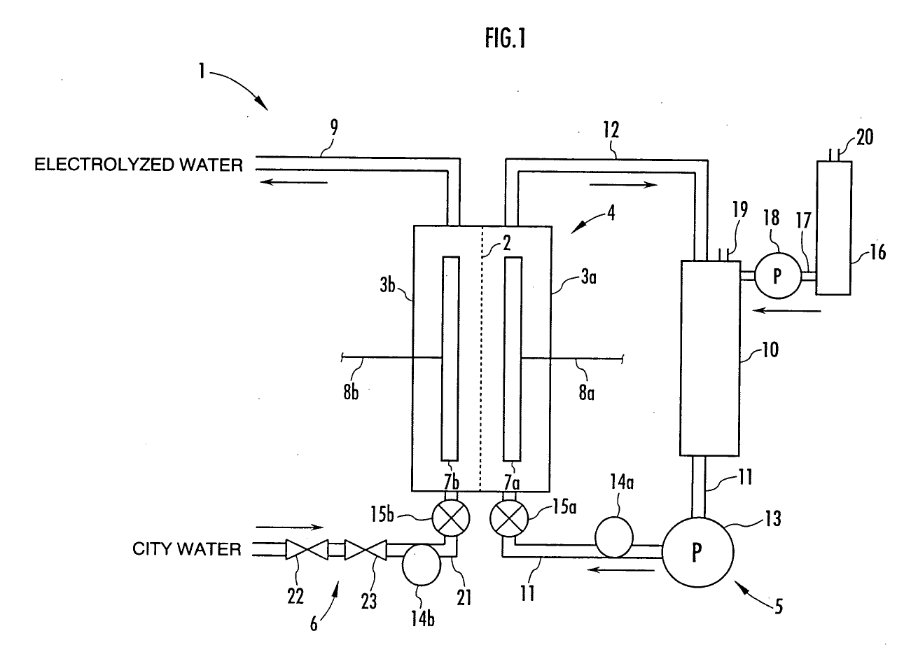

An embodiment of the present invention will be described in detail with reference to the accompanying drawings. FIG. 1 is a diagram schematically showing an electrolyzed water generation apparatus used in accordance with an electrolyzed water generation method representing an embodiment of the present invention.

As shown in FIG. 1, the electrolyzed water generation apparatus 1 in this embodiment is provided with an electrolytic bath 4 having a pair of electrolysis chambers 3a and 3b placed in opposition to each other with an ion-permeable membrane 2 provided between the electrolysis chambers 3a and 3b, an electrolyte aqueous solution circulation system 5 for circulating an electrolyte aqueous solution through the electrolysis chamber 3a, and a raw water supply system 6 for supplying raw water only to the electrolysis chamber 3b. A pair of electrodes 7a and 7b are disposed in the pair of electrolysis chambers 3a and 3b. The electrodes 7a and 7b are connected to a power supply unit (not shown) via conductors 8a and 8b, respectively. An electrolyzed water drawing-out passage 9 for drawing out generated electrolyzed water is provided on the electrolysis chamber 3b.

The electrolyte aqueous solution circulation system 5 is provided with an electrolyte aqueous solution tank 10, an electrolyte aqueous solution supply passage 11 and an electrolyte aqueous solution return passage 12. Through the electrolyte aqueous solution supply passage 11, the electrolyte aqueous solution stored in the electrolyte aqueous solution tank 10 is drawn out from the electrolyte aqueous solution tank 10 and supplied to a bottom portion of the electrolysis chamber 3a. Through the electrolyte aqueous solution return passage 12, the electrolyte aqueous solution in the electrolysis chamber 3a is drawn out through an upper portion of the electrolysis chamber 3a and returned to an upper portion of the electrolyte aqueous solution tank 10. A pump 13 is interposed at an intermediate position in the electrolyte aqueous solution supply passage 11. A flow rate sensor 14a is provided on the electrolyte aqueous solution supply passage 11 on the downstream side of the pump 13. The electrolyte aqueous solution supply passage 11 is connected to the bottom portion of the electrolysis chamber 3a through a flow control valve 15a.

A concentration adjustment agent tank 16 is connected to the electrolyte aqueous solution tank 10 by a concentration adjusting agent passage 17. From the concentration adjustment agent tank 16, a concentration adjustment agent for maintaining the concentration of the electrolyte aqueous solution circulated through the tank 10 within a predetermined range is supplied. A pump 18 is interposed at an intermediate position in the concentration adjusting agent passage 17, through which the concentration adjustment agent stored in the concentration adjustment agent tank 16 is supplied to the tank 10 by the pump 18 to maintain the concentration of the electrolyte aqueous solution within the predetermined range.

An air bleed valve 19 is provided in an upper portion of the tank 10, and an air bleed valve 20 is provided in an upper portion of the tank 16.

The raw water supply system 6 is provided with a raw water supply passage 21 through which raw water supplied from a raw water supply source, e.g., a city water faucet (not shown) to a bottom portion of the electrolysis chamber 3b. A pressure-reducing valve 22, a shut valve 23 and a flow rate sensor 14b are provided at intermediate positions in the raw water supply passage 21. The raw water supply passage 21 is connected to the bottom portion of the electrolysis chamber 3b through a flow control valve 15b provided downstream of the flow rate sensor 14b. The electrolyzed water drawing-out passage 9 is connected to an upper portion of the electrolysis chamber 3b.

While in this embodiment the pump 18 is provided at an intermediate position in the concentration adjusting agent passage 17, an opening/closing valve may be provided in place of the pump 18. In such a case, it is necessary to change the positional relationship between the tanks 10 and 16 so that the tank 16 is placed above than the tank 10.

In a first aspect of this embodiment, the membrane 2 is an anion-exchange membrane; the electrode 7a disposed in the electrolysis chamber 3a is a cathode; and the electrode 7b disposed in the electrolysis chamber 3b is an anode. Accordingly, the electrolysis chamber 3a is a cathode-side electrolysis chamber and the electrolysis chamber 3b is an anode-side electrolysis chamber.

For example, in this case, a sodium chloride aqueous solution is circulated as the above-mentioned electrolyte aqueous solution through the electrolysis chamber 3a by the electrolyte aqueous solution circulation system 5, while city water is supplied as raw water to the electrolysis chamber 3b through the raw water supply passage 21. A predetermined voltage is applied between the electrodes 7a and 7b from the power supply unit (not shown) to electrolyze the sodium chloride aqueous solution and the city water.

In this electrolysis, in the cathode-side electrolysis chamber 3a, sodium ions (Na⁺) and chlorine ions (Cl⁻) are generated by electrolytic dissociation of a sodium chloride, as shown by the following formula. Also, hydrogen (H₂) and hydroxyl ions (OH⁻) are generated by electrolysis of water, thereby obtaining alkaline electrolyzed water.
NaCl→Na⁺+Cl⁻
2H₂O+2e⁻→H₂+20H⁻

Since the anion-exchange membrane is provided as the membrane 2 between the electrolysis chambers 3a and 3b, the sodium ions is blocked by the anion-exchange membrane and cannot move to the anode-side electrolysis chamber 3b. Only the chlorine ions can move into the anode-side electrolysis chamber 3b. As a result, in the anode-side electrolysis chamber 3b, Chlorine (C1₂) generated from the chlorine ions further reacts with water to generate hypochlorous acid (HClO), and oxygen (O₂) and hydrogen ions (H₊) are generated by electrolysis of water to obtain acid electrolyzed water.
2Cl⁻→Cl₂+2e⁻
Cl₂+2H₂O→2HClO+2H⁺
H₂O→½O₂+2H⁺+2e⁻

Accordingly, the acid electrolyzed water containing hypochlorous acid can be drawn out from the upper portion of the anode-side electrolysis chamber 3b through the electrolyzed water drawing-out passage 9. Since sodium ions cannot move into the anode-side electrolysis chamber 3b as descried above, the acid electrolyzed water contains substantially no sodium chloride, so that acceleration of corrosion of metals in an apparatus using the acid electrolyzed water is prevented. In the cathode-side electrolysis chamber 3a, since the sodium chloride aqueous solution is circulated by the electrolyte aqueous solution circulation system 5, the generated alkaline electrolyzed water flows into the sodium chloride aqueous solution to be circulated. Therefore the alkaline electrolyzed water is not discharged as a waste.

During a continuation of the above-described circulation of the sodium chloride aqueous solution through the cathode-side electrolysis chamber 3a, however, the hydroxyl ion concentration increases with time and the sodium chloride aqueous solution exhibits stronger alkalinity. In this aspect of the embodiment, therefore, hydrochloric acid is stored in the concentration adjusting agent tank 16 and is added to the above-described sodium chloride aqueous solution, thereby mainlining the concentration of the sodium chloride aqueous solution within the predetermined range and maintaining the pH within a predetermined region. The concentration of the hydrochloric acid is 2 mol/l or less, e.g., 1 mol/l.

The hydrochloric acid is added while the pH of the sodium chloride aqueous solution is being measured, for example, with a pH sensor provided in the electrolyte aqueous solution circulation system 5. In this case, when the measured value obtained from the pH sensor is larger than a reference value, the hydrochloric acid is added to the sodium chloride aqueous solution to reduce the pH of the sodium chloride aqueous solution below the reference value. More specifically, for example, when the pH of the sodium chloride aqueous solution measured with the pH sensor becomes higher than 9, the pump 18 is operated to add the hydrochloric acid in the concentration adjustment agent tank 16 to the solution in the electrolyte aqueous solution tank 10. When the pH of the sodium chloride aqueous solution becomes lower than 5, the pump 18 is stopped. In this way, the concentration of the sodium chloride aqueous solution can be maintained within the predetermined range. Also, the pH of the sodium chloride aqueous solution can be maintained within a generally neutral region from 5 to 9.

An arrangement using, for example, an energization amount detector provided in the power supply unit (not shown) instead of the pH sensor may alternatively be adopted to compute the amount of reaction of the sodium chloride aqueous solution from the amount of energization at the time of the above-described electrolysis detected with the energization amount detector. In such a case, the hydrochloric acid in the concentration adjustment agent tank 16 is added to the solution in the electrolyte aqueous solution tank 10 according to the computed reaction amount.

In a second aspect of this embodiment, the membrane 2 is an anion-exchange membrane; the electrode 7a disposed in the electrolysis chamber 3a is an anode; and the electrode 7b disposed in the electrolysis chamber 3b is a cathode. Accordingly, the electrolysis chamber 3a is an anode-side electrolysis chamber and the electrolysis chamber 3b is a cathode-side electrolysis chamber.

For example, in this case, an aqueous solution containing a salt is circulated as the electrolyte aqueous solution through the electrolysis chamber 3a by the electrolyte aqueous solution circulation system 5, while city water is supplied as raw water to the electrolysis chamber 3b through the raw water supply passage 21. A predetermined voltage is applied between the electrodes 7a and 7b from the power supply unit (not shown) to electrolyze the alkaline aqueous solution and the city water.

In this electrolysis, a weak alkaline electrolyzed water is obtained in the cathode-side electrolysis chamber 3b. This electrolyzed water is drawn out through the electrolyzed water drawing-out passage 9. On the other hand, in the anode-side electrolysis chamber 3a, weak acid electrolyzed water is generated and the pH of the aqueous solution decreases with time. However, the operation can be continued over a comparatively long time period without adding the concentration adjustment agent in the concentration adjustment agent tank 16 to the solution in the electrolyte aqueous solution tank 10.

In this aspect of the embodiment, a cation-exchange membrane may be provided as the membrane 2. In such a case, the cation in the anode-side electrolysis chamber 3a can move into the cathode-side electrolysis chamber 3b by permeating through the membrane 2, so that the desired electric conductivity between the electrodes 7a and 7b can be easily secured and alkaline electrolyzed water can be easily obtained with low power.

In the case where the membrane 2 is a cation-exchange membrane, the pH of the salt-containing aqueous solution circulated through the anode-side electrolysis chamber 3a tends to decrease with time. A need therefore arises to store an alkaline aqueous solution as a concentration adjusting agent in the concentration adjusting agent tank 16 and to add the alkaline aqueous solution to the solution in the electrolyte aqueous solution tank 10. As a result, the pH of the alkaline aqueous solution circulated through the anode-side electrolysis chamber 3a can be maintained in a generally neutral region, e.g., a region of pH 5 to 9.

An example of the present invention will be described.

### Example

In the electrolyzed water generation apparatus 1 shown in FIG. 1, in an example of the present invention described below, an anion-exchange membrane was used as the membrane 2; the electrode 7a disposed in the electrolysis chamber 3a was a cathode; and the electrode 7b disposed in the electrolysis chamber 3b was an anode. A 0.1 mol/l sodium chloride aqueous solution was circulated at a flow rate of 1 l/min through the electrolysis chamber 3a by the electrolyte aqueous solution circulation system 5, while city water was supplied as raw water at a flow rate of 1 l/min to the electrolysis chamber 3b through the raw water supply passage 21. A predetermined voltage was applied between the electrodes 7a and 7b from the power supply unit (not shown) to perform constant-current electrolysis at 10A.

The pH of the sodium chloride aqueous solution circulated through the electrolysis chamber 3a by the electrolyte aqueous solution circulation system 5 was measured with the pH sensor. When the pH of the sodium chloride aqueous solution became higher than 9, the pump 18 was operated to add 1 mol/l hydrochloric acid from the concentration adjusting agent tank 16 to the solution in the electrolyte aqueous solution tank 10. When the pH of the sodium chloride aqueous solution became lower than 5, the pump 18 was stopped. The operation to start and stop the pump 18 in this way was repeatedly performed. The voltage during this process was 12 to 13 V.

As a result, acid electrolyzed water having pH 3.0 and an effective chlorine concentration of 28 ppm was obtained from the anode-side electrolysis chamber 3b through the electrolyzed water drawing-out passage 9.

The above-described acid electrolyzed water obtained in the example of the present invention was used as a test solution, and changes with time in the number of live germs in the test solution was measured. A comparative example was prepared in which distilled water was used as a test solution, and changes with time in the number of live germs in the test solution was measured. As the germs, colon bacillus and staphylococcus aureus were used. Table 1 shows the results.

TABLE 1

| | | Number of germs (germs/ml) | | | |
|---|---|---|---|---|---|
| | | | 15 | 30 | |
| | | At the | seconds | seconds | 1 minute |
| | | beginning | after | after | after |
| Colon | Example | 7.2 × 10⁵ | 0 | 0 | 0 |
| bacillus | Comparative | 7.2 × 10⁵ | — | — | 8.5 × 10⁵ |
| | example | | | | |
| Staphylococcus | Example | 6.1 × 10⁵ | 0 | 0 | 0 |
| aureus | Comparative | 6.1 × 10⁵ | — | — | 5.6 × 10⁵ |
| | example | | | | |

It is apparent from Table 1 that the acid electrolyzed water obtained in this example has excellent sterilization performance.

In the above-described example, the initial concentration of the sodium chloride aqueous solution circulated through the electrolyte aqueous solution circulation system 5 was 0.1 mol/l. However, it is possible to set the salt concentration to a lower or higher value. For example, the initial concentration of the sodium chloride aqueous solution circulated through the electrolyte aqueous solution circulation system 5 was set to 0.02 mol/l and constant-current electrolysis at 10A was performed. The voltage in this electrolysis was 13 to 15 V.

While in the above-described embodiment, the sodium chloride aqueous solution was circulated through the electrolyte aqueous solution circulation system 5, a potassium chloride aqueous solution may be used in place of the sodium chloride aqueous solution.

What is claimed is:

1. A method of generating electrolyzed water, comprising the steps of:
circulating an electrolyte aqueous solution through a first electrolysis chamber as one of a pair of opposed electrolysis chambers having an ion-permeable membrane therebetween;
supplying raw water only to a second electrolysis chamber as the other of the pair of electrolysis chambers; and
drawing out electrolyzed water generated in the second electrolysis chamber by applying a voltage between a pair of electrodes disposed in the electrolysis chambers on the opposite sides of the membrane so that the raw water and the electrolyte aqueous solution are electrolyzed,
wherein a concentration of the electrolyte aqueous solution circulated through the first electrolysis chamber is maintained within a predetermined range.

2. The method of generating electrolyzed water according to claim 1, wherein the membrane is an anion-exchange membrane; the electrolyte aqueous solution is circulated through a cathode-side electrolysis chamber as the first electrolysis chamber; raw water is supplied only to an anode-side electrolysis chamber as the second electrolysis chamber; and the acid electrolyzed water generated in the anode-side electrolysis chamber is drawn out.

3. The method of generating electrolyzed water according to claim 2, wherein the electrolyte aqueous solution is a sodium chloride aqueous solution, and a concentration of the sodium chloride aqueous solution is maintained within the predetermined range by adding hydrochloric acid to the sodium chloride aqueous solution.

4. The method of generating electrolyzed water according to claim 3, wherein a pH of the sodium chloride aqueous solution is measured and the concentration of the sodium chloride aqueous solution is maintained within the predetermined range in such a manner that when the measured value is larger than a reference value, hydrochloric acid is added to the sodium chloride aqueous solution so that the pH of the sodium chloride aqueous solution becomes lower than the reference value.

5. The method of generating electrolyzed water according to claim 3, wherein an amount of reaction of the sodium chloride aqueous solution is computed from an amount of energization during electrolysis and the concentration of the sodium chloride aqueous solution is maintained within the predetermined range by adding hydrochloric acid to the sodium chloride aqueous solution according to the computed reaction amount.

6. The method of generating electrolyzed water according to claim 2, wherein the electrolyte aqueous solution is a potassium chloride aqueous solution, and a concentration of the potassium chloride aqueous solution is maintained within the predetermined range by adding hydrochloric acid to the potassium chloride aqueous solution.

7. The method of generating electrolyzed water according to claim 6, wherein a pH of the potassium chloride aqueous solution is measured and the concentration of the potassium chloride aqueous solution is maintained within the predetermined range in such a manner that when the measured value is larger than a reference value, hydrochloric acid is added to the potassium chloride aqueous solution so that the pH of the potassium chloride aqueous solution becomes lower than the reference value.

8. The method of generating electrolyzed water according to claim 6, wherein an amount of reaction of the potassium chloride aqueous solution is computed from an amount of energization during electrolysis and the concentration of the potassium chloride aqueous solution is maintained within the predetermined range by adding hydrochloric acid to the potassium chloride aqueous solution according to the computed reaction amount.

9. The method of generating electrolyzed water according to claim 1, wherein the membrane is an anion-exchange membrane; the electrolyte aqueous solution is circulated through an anode-side electrolysis chamber as the first electrolysis chamber; raw water is supplied only to a cathode-side electrolysis chamber as the second electrolysis chamber; and the alkaline electrolyzed water generated in the cathode-side electrolysis chamber is drawn out.

10. The method of generating electrolyzed water according to claim 1, wherein the membrane is a cation-exchange membrane; the electrolyte aqueous solution is circulated through an anode-side electrolysis chamber as the first electrolysis chamber; raw water is supplied only to a cathode-side electrolysis chamber as the second electrolysis chamber; and the alkaline electrolyzed water generated in the cathode-side electrolysis chamber is drawn out.

11. An apparatus for generating electrolyzed water, comprising:
a pair of opposed electrolysis chambers having an ion-permeable membrane therebetween;
an electrolyte aqueous solution circulation means for circulating an electrolyte aqueous solution through a first electrolysis chamber as one of the pair of electrolysis chambers;
a raw water supply means for supplying raw water only to the second electrolysis chamber as the other of the pair of electrolysis chambers; and
an electrolyzed water drawing-out means for drawing out electrolyzed water generated in the second electrolysis chamber by applying a voltage between a pair of electrodes disposed in the electrolysis chambers on the opposite sides of the membrane so that the raw water and the electrolyte aqueous solution are electrolyzed,
wherein the electrolyte aqueous solution circulation means includes concentration maintaining means for maintaining a concentration of the electrolyte aqueous solution circulated through the first electrolysis chamber within a predetermined range.

12. The apparatus for generating electrolyzed water according to claim 11, wherein the membrane is an anion-exchange membrane, the apparatus comprising an electrolyte aqueous solution circulation means for circulating the electrolyte aqueous solution through a cathode-side electrolysis chamber as the first electrolysis chamber, a raw water supply means for supplying raw water only to an anode-side electrolysis chamber as the second electrolysis chamber and an electrolyzed water drawing-out means for drawing out acid electrolyzed water generated in the anode-side electrolysis chamber.
